(19) United States
(12) Patent Application Publication
(10) Pub. No.: US 2008/0021882 A1
(43) Pub. Date: Jan. 24, 2008

(54) METHOD AND APPARATUS FOR RETRIEVING A 3-DIMENSIONAL MODEL

(75) Inventors: Jiantao Pu, Beijing (CN); Yi Liu, Beijing (CN); Hongbin Zha, Beijing (CN); Weibin Liu, Beijing (CN); Yusuke Uehara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED

(21) Appl. No.: 11/770,123

(22) Filed: Jun. 28, 2007

Related U.S. Application Data
(63) Continuation of application No. PCT/CN04/01591, filed on Dec. 31, 2004.

(51) Int. Cl. G06F 17/30

(52) U.S. Cl. 707/3

(57) ABSTRACT

The invention discloses a search method of 3D model and device thereof. As stated in the invention, it transforms the query model and the object model into the set of 2D-slide polygons respectively; calculates the similarity between each 2D slice in the query model and the object mode by accumulating the similarities of all couples of 2D slices; and determines the search result according to the said total similarity. In accordance with the invention, it could be easily realize the search function of 3D model, and it is not sensitive to geometric noise, thus there's no need to look for the characteristic correspondence between models.

This is a continuing application, filed under 35 U.S.C. §111(a), of International Application PCT/CN2004/001591, filed Dec. 31, 2004, the disclosure of which is herein incorporated by reference.

### FIELD OF THE INVENTION

The present invention relates to method and apparatus for retrieving a 3-dimensional model

### DESCRIPTION OF THE RELATED ART

With the development of three-dimensional computer graphics and the related hardware technology, three-dimensional models have been playing a very important role in many mainstream fields of application such as machine manufacturing, games, biochemistry, medical science, electronic business, arts and virtual reality. It has therefore become a key problem facing these fields of application as how to find the required models in a quick and exact manner. Generally, a three-dimensional model can be described from many angles, such as color, texture, function, material and geometry. Of these, geometry is the most efficient way to describe a three-dimensional model. Moreover, geometry is the most intuitive way in terms of visual perception of a human being. Consequently, measurement of similarity in geometry of three-dimensional models has become the key issue in the research on three-dimensional model retrieval as it is directly related to the efficiency of the 3D-model retrieving system.

Many methods have been proposed for the retrieval of 3D models. Robert et al. (Robert, O., Thomas, F., Bernard, C., and David, D., “Shape Distribution”, ACM Transactions on Graphics, 21(4): 807-832, 2002) proposed a shape distribution method in which the problem of shape matching is simplified to a problem of comparison between probability distributions by defining a shape function and a sampling method. The implementation of this method is relatively simple and there is no need for position correction and feature matching, etc. Mihael et al. (Mihael, A., Gabi, K., Hans-Peter, K., and Thomas, S., “3D Shape Histogram for Similarity Search and Classification in Spatial Databases”, Proc. 6^{th} International Symposium on Spatial Databases, pp. 207-228, Hongkong, China, 1999.) proposed a method in which the distribution of features (area and volume, etc.) of a 3D model are described with a histogram, and shape matching between two models is performed by normalizing the distribution of area and calculating a L2 error. Elad et al. (Elad, M., Tal, A., and Ar., S., “Content based Retrieval of VRML Objects—An Iterative and Interactive Approach”, Proc. 6^{th} Eurographics Workshop in Multimedia, pp. 107-118, Manchester UK, 2002.) proposed to describe features of a shape under a concept of moment to represent the differences between models. Horn et al. (Horn, B., “Extended Gaussian Images”, Proc. IEEE 72, 12(12), pp. 1671-1686. New Orleans, USA, 1984.) proposed to describe a 3D model on the basis of the distribution of normal line vector on the surface of an object, assign an EGI (Extended Gaussian Image) to each model based on the main axis of the model, and then calculate similarity between two aligned EGIs through a L2 error. Zhang et al. (Zhang, C., and Chen, T., “Indexing and Retrieval of 3D Models Aided by Active Learning”, Proc. ACM Multimedia 2001, pp. 615-616 Ottawa, Ontario, Canada, 2001.) proposed many region based features for a 3-D model, such as volume/area ratio, invariant moment, and Fourier transformation coefficient etc., and proposed to describe feature of an 3D object with all these features. Motofumi (Motofumi, T. S., “A Web-based Retrieval System for 3D Polygonal Models”, Proc. Joint 9^{th} IFSA World Congress and 20 NAFIPS International Conference (IFSA/NAFIPS 2001), pp. 2271-2276, Vancouver, 2001.) proposed to describe a 3D model with a combination of plural features in a web-based retrieval system, which features specifically include tensors, normal-line, volume, polygonal vertices and polygonal face. A common feature of the aforementioned methods is that the 3D shape is described by summarizing a plurality of global features, thus it is relatively easy to implement, stable in performance and has good transformation invariability. But these methods are not perfect in the description of information on the shape, do not take the local features into consideration, and are slow in computer processing and have big delay in the search due to the great number of features involved.

Hilaga et al. (Hilaga, M., Shinaagagawa, Y., Kohmura, TV, and Kunii, T. L., “Topology Matching for Fully Automatic Similarity Estimation of 3D Shapes”, Proc. SIGGRAPH 2001, Computer Graphics Proceedings, Annual Conference Series, pp. 203-212, Los Angeles, USA, 2001.) proposed a method of “topology matching” to perform the 3D model retrieval on the basis of geometric structure, in which similarity calculation is performed by comparing a multi-resolution Reeb diagram. The multi-resolution Reeb diagram is the skeletal and topological structure of a 3D shape under various different resolution levels, and can be constructed by applying a continuous geodesic distance function to a 3D shape. The method employs a coarse-to-fine strategy in the matching of models. Recently, Sundar et al. (Sundar, H. Silver, D., Gagvani, and Dickinson, S., “Skeleton Based Shape Matching and Retrieval”, Proc. Shape Modeling International 2003, pp. 130-142, Seoul, Korea, 2003.) proposed another 3D model comparison method based on the concept of skeleton, in which the geometric and topological information are encoded in a form of skeletal diagram, and the skeletons are matched and compared with a diagram matching method. Methods based on skeleton describe the global features of a 3D object and at the same time describe the local features thereof, which makes it possible to not only compare the global shapes but also compare the local shapes. However, since such methods require huge computational resources, they are difficult for application in a real-time system, and it is also impossible to guarantee the precision and stability of the alignment of nodes in the skeletal diagram.

### SUMMARY OF THE INVENTION

The object of the present invention is to solve the problems and deficiencies in the aforementioned existing 3D model retrieval methods.

To this end, in one aspect of the present invention, there is provided a method for retrieving three-dimensional models, comprising the steps of: transforming a query model and a target model into a set of two-dimensional slice polygons, respectively; calculating a similarity between corresponding two-dimensional slices; accumulating all similarities to obtain a total similarity; and extracting the target model if the total similarity satisfies a predetermined condition.

In another aspect of the present invention, there is provided an apparatus for retrieving three-dimensional models, comprising: a transforming means for transforming a query model and a target model into a set of two-dimensional slice polygons, respectively; a similarity calculating means for calculating a similarity between corresponding two-dimensional slices, and accumulating all similarities to obtain a total similarity; and a retrieval result determining means for determining whether the total similarity satisfies a predetermined condition, and extracting the target model as a retrieval result if the condition is satisfied.

The present invention proposes a form of description capable of describing a 3D shape precisely. Specifically, the present invention proposes a way to describe shape with a set of slice polygons. The more is the number of the slices, the closer is the shape formed by accumulating the slices to the original shape of the model, and the more precise is the calculated similarities. Since the original shape can be completely reconstructed by the slices, this description embodies nearly all features of the 3D shape, and by this description the problem of shape matching can be converted into a comparison of similarities between 2D slices. The present invention retains as far as practically possible all geometric features of the 3D model, thus ensures satisfactory similarity comparison result of shapes.

This invention is mainly advantageous in easy implementation, insensitivity to geometric noises, transformation invariability, and no need for feature matching between models.

### BRIEF DESCRIPTION OF THE DRAWINGS

The invention will be described in detail below with reference to the drawings, in which:

FIG. 1 shows an overall flowchart of the method for retrieving 3D model according to this invention;

FIG. 2 is a diagram schematically showing a 3D model according to this invention;

FIG. 3 is a diagram schematically showing the 3D model of FIG. 2 sliced into 30 slices;

FIG. 4 is a diagram schematically showing the 3D model of FIG. 2 sliced into 100 slices;

FIG. 5 is a diagram schematically showing a 3D model enclosing box obtained by an inertia main axis method;

FIG. 6 is a diagram schematically showing a 3D model enclosing box obtained by a maximum normal-line distribution method according to this invention;

FIG. 7 shows examples of generation of the 2D slices;

FIG. 8 is a diagram schematically showing the sampling result of the 2D slices according to this invention;

FIG. 9 is a diagram schematically showing shape distribution functions of two polygons; and

FIG. 10 is a block diagram schematically showing the apparatus for retrieving 3D models according to this invention.

### DETAILED DESCRIPTION OF THE PREFERRED EMBODIMENT

The present invention is described in detail below with reference to the accompanying drawings.

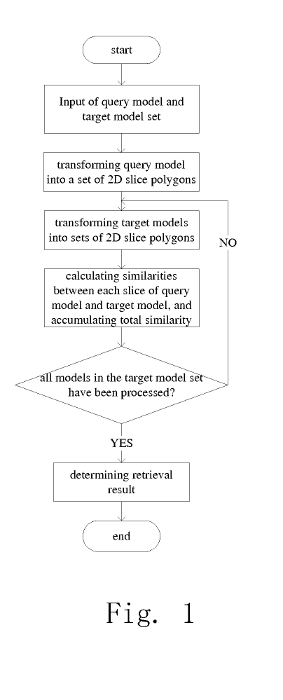

The present invention can be embodied as a method for retrieving 3D models. FIG. 1 shows an overall flowchart of the method for retrieving 3D models according to this invention. As shown in FIG. 1, first a query model and a set of target models are inputted. Then the query model is transformed into a set of 2D slice polygons. All target models are transformed in sequence into sets of 2D slice polygons. Then similarities between the corresponding slices of the query model and the target models are calculated respectively and accumulated to obtain a total similarity, and hence to determine the retrieval result based on the calculated total similarity. The method of the invention is explained in detail below.

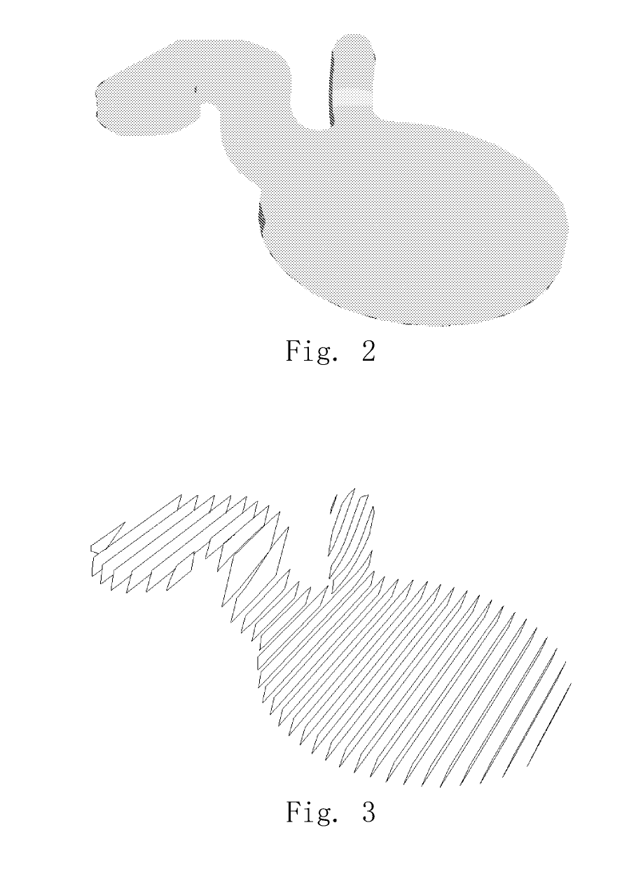

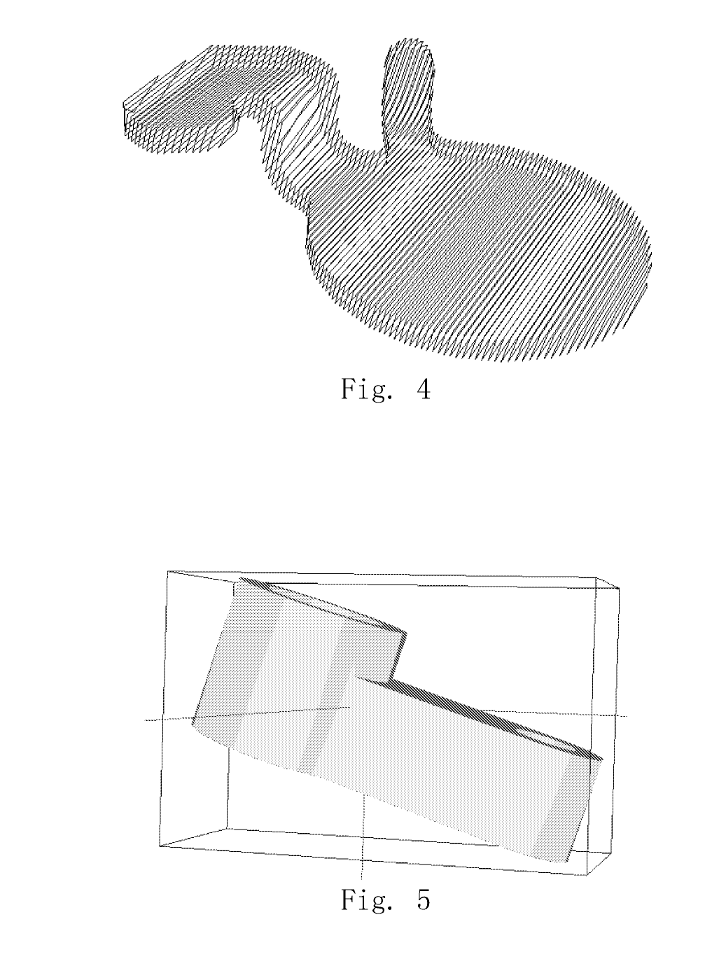

The key to the present invention lies in proposing a form of description capable of describing a 3D shape in a precise manner. Put in other words, the present invention proposes a way to describe a shape with a set of slice polygons. FIG. 2 shows a common 3D model, FIG. 3 shows the model of FIG. 2 sliced into 30 slices, and FIG. 4 shows the model of FIG. 2 sliced into 100 slices. As can be seen, the slices in FIG. 4 represent more vividly the geometric shape of the original 3D model shown in FIG. 2, as the more is the number of the slices, the closer is the shape finally formed by accumulating the slices to the original shape of the model. Since the original shape can be perfectly reconstructed by these slices, such an description embodies nearly all features of the 3D shape, and by employing this description the problem of shape matching can be converted into comparison of similarities between 2D slices. To this end, there are the following problems to be solved:

(1) Selection of slicing direction: in order to perform similarity comparison between shapes, a set of orthogonal directions has to be uniquely determined for each model. From the viewpoint of human visual perception, the slicing sequences of different models must have the same slicing direction in order to guarantee the feasibility of similarity comparison between the models. With regard to a single 3D object, if it is sliced along main axis directions of two different enclosing boxes, different slice sequences will be obtained, although they represent the same object, it is impossible to perform similarity comparison.

(2) Slicing method: this is to slice a 3D grid model into a series of slices with a plane along a predetermined direction. However, it does not suffice to represent the slices with intersection points alone to perform similarity calculation, as it is also required to reasonably organize these intersection points to describe the topological structure of the slices. For instance, a series of closed polygonal slices can be employed to exactly reflect the geometric shapes located at the slicing positions.

(3) Measurement of similarities between slices: once the slice sequences of two models are obtained, the next step will be to measure the similarities therebetween. Thus, there is a need on one hand to determine certain parameters to describe the 2D geometric shapes of the slices, and there is a need on the other hand to measure the similarities between these slice sequences in a quantitative way.

Firstly, the slicing direction of the 3D model has to be determined, that is to say, an enclosing box defined by three orthogonal axes has to be determined.

Although in theoretical physics a group of uniquely determined orthogonal axes can be obtained by the inertia main axis method, such a group of orthogonal axes is not consistent with human visual perception under many circumstances, thereby making it impossible to measure the similarities amongst 3D models from the viewpoint of visual perception. Shown in FIG. 5 is an enclosing box obtained by the inertia main axis method. If this enclosing box is employed to slice a 3D model, two originally similar models will be dissimilar in their slices. In view of this, the present invention proposes a method for obtaining orthogonal axes of an enclosing box, as called “maximum normal-line distribution”, wherein the orthogonal axial direction is determined from the maximum distribution of the normal-line.

The present invention determines enclosing box of a 3D) model by the following steps.

1. A normal direction N^{k} can be calculated for each triangle grid Δp^{k}q^{k}r^{k} of a 3D model, by cross multiplication of arbitrary two sides of the triangle.

$${N}^{k} = \frac{{p}^{k} {q}^{k} \times {q}^{k} {r}^{k}}{‖ {p}^{k} {q}^{k} \times {q}^{k} {r}^{k} ‖} .$$

2. Area a^{k} of each triangle is calculated, and areas of all triangles having identical or opposing normal directions are accumulated. It is regarded here that the normal-lines having identical or opposing directions have the same distribution.

3. Direction of normal-line distribution with the maximum area is selected as the first main axis b^{u}, and a second main axis b^{v} is determined from the remaining normal-line distributions. The second main axis b^{v} must simultaneously satisfy the two conditions of: (1) having the maximum area of normal-line distribution, and (2) being orthogonal to the first main axis b^{u}.

4. b^{u} and b^{v} are cross multiplied to obtain a third main axis b^{w}=b^{u}×b^{v}.

5. In order to determine the center, the half length and the positive direction of the main axis of the enclosing box, the points on the 3D model are projected in the directions of the main axes, and the maximum value and the minimum value in each direction are then determined, which values determine the size and position of the enclosing box. The positive direction of each main axis is decided as the side of the enclosing box that lies farther to the barycenter of the model. The inertia main axis is unique for each model, and because of this uniqueness, many retrieval methods make use of such an inertia main axis to align 3D models so as to perform similarity measurement. However, the inertia main axis based enclosing box obtained by the conventional method does not have good robustness, and is apt to be changed considerably by noises of the surface of the 3D model. The method for obtaining orthogonal axis of the enclosing box based on the maximum normal-line distribution as proposed in the present invention not only obtains the unique main axis coordinate system of the 3D model, but is also almost immune to influences by geometric noises and has relatively high robustness.

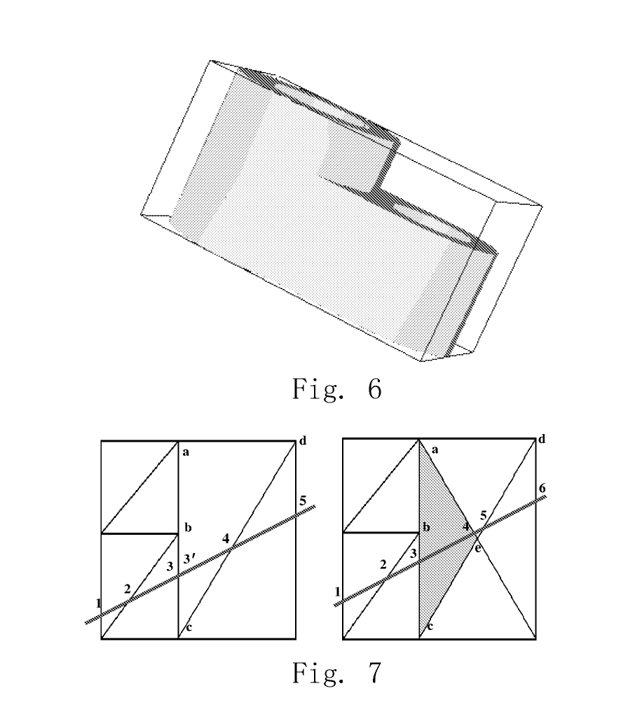

FIG. 6 shows an example of enclosing box of a 3D model obtained by the maximum normal-line distribution method according to the present invention.

Once the enclosing box of the 3D model is determined, 2D slice sequence of the 3D model are then generated.

To a grid model, the generation of 2D slice sequence means to use a plane to sequentially intersect the model along the slicing direction, and finally generate a series of intersection points. However, since the generated intersection points do not have obvious correlation amongst one another, there is therefore a need to organize these intersection points on the basis of the connection relationship of the grid. With regard to a polygonal grid, an intuitive way is to describe the slices with a set of polygons. The present invention generates the 2D slices of the 3D model by the following steps.

1. A set of planes, which are equidistant to each other and perpendicular to the corresponding main axial direction, is respectively determined along the directions of three main axes orthogonal to each other.

2. Intersection points sequences between each plane and each polygonal grid are calculated in sequence, and the intersection points and the intersecting triangles are respectively stored in two different arrays SIP and SIT. Any intersection point cannot be stored twice.

3. For each slice, the intersection points are organized into a set of polygons on the basis of their adjoining relationship in the surface of the model. Specifically, (1) one point is randomly selected from the SIP and marked as accessed point; (2) One point is selected from the remaining non-accessed intersection points, it is judged whether this point is adjacent to the previous point, and this point is then marked as accessed point. Adjacent or not is judged by whether the two points are located on two different sides of a single triangle in the SIT. If two points are judged to be adjacent to each other, the two points are judged to be two adjacent vertices of a single pologon. (3) The point selected in step (1) is taken as a reference point, and step (2) is repeated until no point in the SIP satisfies the conditions in step (2). Till now, all accessed points form a closed loop and are regarded as a vertex sequence of a polygon. (4) It is checked whether there is any point in the SIP that has not been accessed, if yes, the aforementioned steps are repeated from step (1), otherwise the process of generating polygon set is ended. Thus, a set of slice polygons is generated, and the process enters the next stage.

4. Illogical polygons are removed. It is obvious that one polygon consists of at least three vertices, therefore polygons containing less than three vertices, if any, are removed.

After the aforementioned processes, a series of slices consisting of polygons is obtained. However, this method is suitable for only grid models with relatively ideal structures.

As shown in FIG. 7, the sectional line at the middle of the figure denotes a slicing plane. Vertex b belongs to the polygon to the left, but it is nonetheless located on a side of the triangle acd to the right, such a vertex is referred to as T-type vertex. Each of points 1, 2, 3, 4 and 5 is intersection point between the polygonal grid and the slicing plane. Two overlapping intersection points 3 and 3′ are present at the location of point 3, of which 3 is the intersection point between the slicing plane and the side be while 3′ is the intersection point between the slicing plane and the side ac. According to the aforementioned step 2, only one of the intersection points is to be retained, and the other is to be discarded. Thus, if intersection point 3 is retained, the algorithm will not regard points 3 and 4 as two adjacent vertices of a single polygon, this is because be and cd are not two sides of a single triangle. To the contrary, if the point 3′ is retained, the correct result will be obtained. To address this problem, a special treatment is adopted in the present invention: if there exists two identical intersection points, the two sides where the two intersection points are located are simultaneously stored, and the point is flagged. When the algorithm accesses to this point, it is judged whether the sides on which the point is located belong to the same triangle.

As shown in FIG. 7, the sectional line at the middle of the figure denotes a slicing plane. The gray region in the figure is referred to as “side crevasse”, and this region is not a part of the grid surface. At this location the polygons to the left side and the right side are not well connected. When it comes to access point 3, since the triangle ace is not a part of the polygonal grid, the algorithm will not regard point 4 as a vertex adjacent to the point 3. To this end, a judgment is introduced into the present invention to check whether the sides where the two points are located constitute a triangle, if yes, these two points are regarded as adjacent vertices of a polygon.

Till now, a series of slice sequences consisting of polygon set can be obtained with regard to any arbitrary 3D grid model.

The slice sequences consisting of polygon set can represent the shape distribution features of the 3D model in a given direction. Consequently, the problem of 3D model retrieval can be converted into similarity measurement between sets of 2D polygons. To this end, the present invention proposes a 2D shape distribution method, which is specifically consisting of the following three steps:

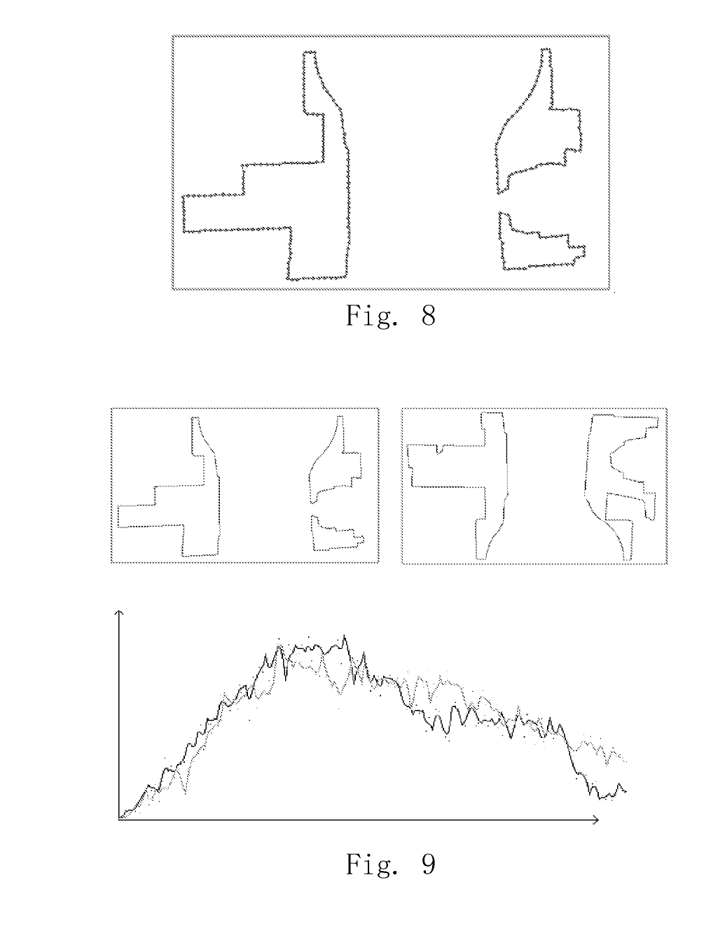

1. As regards a set of polygons in the slices, the present invention adopts a strategy of even edge sampling. Assume the total length of the sides is L and the total number of sampling points is n, the number of sampling point k and the position of the sampling point are defined as follows for a side defined by two vertices Aᵢ and Aⱼ (where i and j are serial number of vertex).

$$k = \frac{n}{L} \times ‖ {A}_{i} {A}_{j} ‖$$

$${S}_{i} = {A}_{i} + i \times \frac{L}{n} {D}_{i}$$

wherein Dⱼ is the normalized vector from Aᵢ to Aⱼ, and the sampling result is as shown in FIG. 8. Here, the more the sampling points are, the higher is the calculation precision.

2. The present invention employs the D2 function to calculate the distance distribution. The so-called D2 function is for calculating the Euclidean distance between any two arbitrary sampling points. FIG. 9 shows shape distribution curves of two polygons, and the horizontal axis in the figure denotes the distance between two arbitrary points, and the vertical axis denotes number of sampling points having equal distance. The black curve represents the shape distribution of the polygon to the left, and the gray curve represents the shape distribution of the polygon to the right.

3. Normalization is performed before the similarity measurement. There are generally two normalization methods: (a) alignment based on the maximum D2 distance, and (b) alignment based on the average D2 distance. In the former one, the maximum values of two shape distributions must be adjusted to be identical with each other, whereas the latter requires the average values of the two to be identical. The present invention employs the latter method to lower the influences of noises. Thus, the final similarity can be quantitatively calculated according to the following equation:

$$Similarity = {\sum }_{d = 1}^{3} {\sum }_{i = 0}^{n} {\sum }_{j = 0}^{m} {( {s}_{dif} - {k}_{dif} )}^{2}$$

wherein d represents number of slicing directions, in this case 3, n represents number of slices along one direction, m represents number of histograms of the shape distribution curves, and s and k represent the number of probability distributions at a given distance.

Thus, the method according to this invention calculates the similarities between the query model and each of the target models, so as to determine the retrieval result on the basis of the similarity calculation result. For instance, after all models contained in an inputted set of target models are processed as above, the calculated similarities are ranked, and the target model having the highest similarity is extracted as the retrieval result. Alternatively, a threshold value can be determined in advance, if the similarity of a target model to a query model is equal to or greater than this threshold value, this model is extracted as the retrieval result. The method for retrieving three-dimensional models according to the present invention is hence completed.

In comparing the 3D model slices, the slices can be rotated arbitrarily as long as the consistency to the slicing planes of the 3D model and the sequences of slice can be guaranteed. In addition, the models retrieved in the present invention satisfactorily match the visual perception of a human being.

Moreover, the query model and the target model are processed in real-time in the above description. But this is merely by way of an example, as it is also possible according to the present invention to preprocess all models in the target model set to obtain features of all models, and perform the retrieval on this basis.

The retrieval method of this invention has been explained in detail above. Additionally, the present invention can also be embodied as an apparatus for retrieving three-dimensional models.

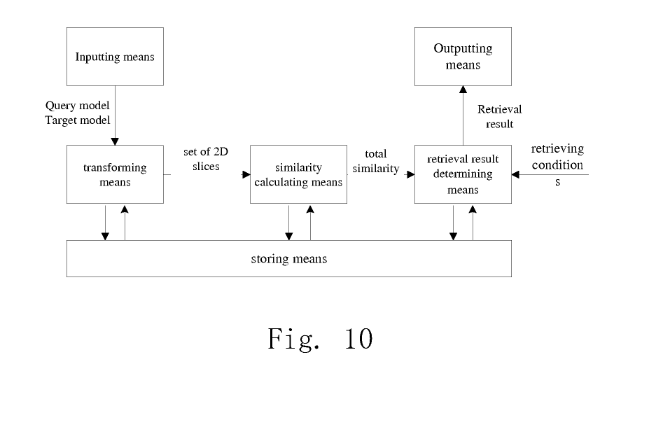

FIG. 10 is a block diagram showing the apparatus for retrieving 3D models according to this invention. As shown in FIG. 10, the apparatus for retrieving 3D models according to this invention may comprise a transforming means for transforming a query model and a target model into a set of two-dimensional slice polygons, respectively; a similarity calculating means for calculating a similarity between corresponding slices of the query model and the target model, and calculating a total similarity between the two models; and a retrieval result determining means for determining a result of the retrieval based on the result of similarity calculation.

The apparatus for retrieving 3D models according to this invention may further comprise an inputting means, an outputting means and a storing means. The inputting means and the outputting means function as interfaces of the retrieving apparatus of the invention to the outside. The inputting means inputs the query model and the target model from the outside. The inputting means can be, for example, a hard disc driver, an optical disc driver or a network interface. The outputting means outputs the retrieval result to the outside. The outputting means can be, for example, a hard disc driver or a network interface. The storing means stores any data used in or generated during the process of retrieval.

The apparatus for retrieving 3D models according to this invention can be embodied as a properly programmed computer. For instance, the transforming means, the similarity calculating means and the retrieval result determining means of this invention can be configured as processors running proper programs and associated memories. The transforming means, the similarity calculating means and the retrieval result determining means of this invention execute the aforementioned retrieving method of this invention.

Specifically, the transforming means obtains the enclosing box of the query model and the target model with the maximum normal-line distribution method, and obtains a set of 2D slice polygons of the query model and the target model by a set of planes that are parallel to each plane of the enclosing box. The similarity calculating means calculates the similarities between each of the 2D slices of the query model and the target model, and calculates the total similarity of two 3D models. The retrieval result determining means determines the retrieval result based on the total similarity as calculated.

As described above, the apparatus for retrieving 3D models according to this invention executes the aforementioned retrieving method, further explanation thereto is hence omitted in this context.

The method and apparatus for retrieving three-dimensional models according to the present invention are described in detail above. It should be understood, however, that the method and apparatus of this invention could be variously modified and improved within the scope defined by the claims as attached.

1. A method for retrieving three-dimensional models, comprising steps of:
transforming a query model and a target model into a set of two-dimensional slice polygons, respectively;
calculating a similarity between corresponding slices of the query model and the target model;
accumulating the similarities of all the two-dimensional slices to obtain a total similarity between the query model and the target model; and
determining a result of the retrieval based on said total similarity.

2. The method of claim 1, wherein the step of transforming into the set of two-dimensional slice polygons comprises:
obtaining an enclosing box of the three-dimensional model with a maximum normal-line distribution method; and
obtaining the set of two-dimensional slice polygons by using a set of planes which are normal to the main axis of the enclosing box and are equidistant to each other, as slicing planes.

3. The method of claim 2, wherein the step of obtaining the enclosing box comprises:
determining a normal direction for any triangle grids composing the three-dimensional model
calculating an area of each triangle grid, and accumulating the areas of all the triangle grids with same or opposite normal direction;
selecting a normal direction with the maximum accumulated area as the first main axis of the enclosing box;
locating a second main axis which has the maximum accumulated area and is orthogonal to the first main axis, from among the remaining normal lines;
obtaining a third main axis by cross multiplying the first and second main axis; and
projecting the vertexes of the three-dimensional model in the direction of the main axes, locating the maximum value and minimum values in each direction, so as to determine the size and location of the enclosing box.

4. The method of claim 2, wherein the step of obtaining the set of two-dimensional slice polygons comprises:
determining a set of planes which are equidistant to each other and perpendicular to the corresponding main axis, along the directions of three main axes of the enclosing box which are orthogonal to each other;
determining a series of intersection points of each plane and triangle grid; and
arranging the intersection points into a set of polygons based on the adjacency relationships of the intersection points on the surface of the model.

5. The method of claim 4, further comprising:
discarding the polygon slice if the number of closed vertexes constituting the polygonal slice is less than 3.

6. The method of claim 4, further comprising:
when the intersection point belongs to sides of two different triangles, retaining the two different sides and marking the intersection point in order to determine definitely which triangle the intersection point belongs to.

7. The method of claim 4, wherein
when the triangle to which the said intersection point belongs does not lie on said three-dimensional model, the method further comprises:
if the side on which the said intersection point and the adjacent intersection point lie can constitute a triangle, determining the two intersection points to be adjacent vertexes of the polygonal slice; and
if the side on which the two intersection points lie can not constitute a triangle, discarding the two intersection points.

8. The method of claim 1, further comprising a step of normalizing the similarities with regard to mean D2 distance.

9. An apparatus for retrieving three-dimensional models, comprising:
a transforming means for transforming a query model and a target model into a set of two-dimensional slice polygons, respectively;
a similarity calculating means for calculating a similarity between corresponding slices of the query model and the target model, and accumulating the similarities of all the two-dimensional slices to obtain a total similarity between the query model and the target model; and
a retrieval result determining means for determining a result of the retrieval based on said total similarity.

10. The apparatus of claim 9, wherein the transforming means obtains an enclosing box of the three-dimensional model by using a maximum normal-line distribution method, and obtains the set of two-dimensional slice polygons by using a set of planes which are normal to the main axes of the enclosing box and are equidistant to each other as slicing planes.

11. The apparatus of claim 10, wherein the transforming means operates to:
determine a normal direction for any triangle grids composing the three-dimensional model
calculate an area of each triangle grid, and accumulate the areas of all the triangle grids with same or opposite normal direction;
locate a normal direction with the maximum accumulated area as the first main axis of the enclosing box;
select a second main axis which has the maximum accumulated area and is orthogonal to the first main axis, from among the remaining normal lines;
obtain a third main axis by cross multiplying the first and second main axis; and
project the vertexes of the three-dimensional model in the direction of the main axes, locating the maximum value and minimum value in each direction, so as to determine the size and location of the enclosing box.

12. The apparatus of claim 10, wherein the transforming means further operates to:
determine a set of planes which are equidistant to each other and perpendicular to the corresponding main axis, along the directions of three main axes of the enclosing box which are orthogonal to each other;
determine a series of intersection points of each plane and the triangle grids; and
arrange the intersection points into a set of polygons based on the adjacency relationships of the intersection points on the surface of the model.

13. The apparatus of claim 12, wherein the transforming means further operates to:
discard the polygonal slice if the number of the closed vertexes constituting the polygon slice is less than 3.

14. The apparatus of claim 12, wherein
when the intersection point belongs to sides of two different triangles, the transforming means further operates to
retain the two different sides and mark the intersection point, in order to determine definitely which triangle the intersection point belongs to.

15. The apparatus of claim 12, wherein when the triangle to which the said intersection point belongs does not lie on said three-dimensional model, the transforming means further operates to:
determine the two intersection pints to be adjacent vertexes of the polygon slice if the side on which the said intersection point and the adjacent intersection point lie can constitute a triangle, and
discard the two intersection points if the side on which the two intersection points lie can not constitute a triangle.

16. The apparatus of claim 9, wherein the transforming means further operates to normalize the similarities with regard to mean D2 distance.

17. A computer readable medium storing a program to cause an information processing device to execute operations including retrieving three-dimensional models, said operations comprising:
transforming a query model and a target model into a set of two-dimensional slice polygons, respectively;
calculating a similarity between corresponding slices of the query model and the target model;
accumulating the similarities of all the two-dimensional slices to obtain a total similarity between the query model and the target model; and
determining a result of the retrieval based on said total similarity.

18. The computer readable medium of claim 17, wherein the transforming into the set of two-dimensional slice polygons comprises:
obtaining an enclosing box of the three-dimensional model with a maximum normal-line distribution method; and
obtaining the set of two-dimensional slice polygons by using a set of planes which are normal to the main axis of the enclosing box and are equidistant to each other, as slicing planes.

19. The computer readable medium of claim 18, wherein the obtaining of the enclosing box comprises
determining a normal direction for any triangle grids composing the three-dimensional model
calculating an area of each triangle grid, and accumulating the areas of all the triangle grids with same or opposite normal direction;
selecting a normal direction with the maximum accumulated area as the first main axis of the enclosing box;
locating a second main axis which has the maximum accumulated area and is orthogonal to the first main axis, from among the remaining normal lines;
obtaining a third main axis by cross multiplying the first and second main axis; and
projecting the vertexes of the three-dimensional model in the direction of the main axes, locating the maximum value and minimum values in each direction, so as to determine the size and location of the enclosing box.

20. The computer readable medium of claim 19, wherein the obtaining of the set of two-dimensional slice polygons comprises:
determining a set of planes which are equidistant to each other and perpendicular to the corresponding main axis, along the directions of three main axes of the enclosing box which are orthogonal to each other;
determining a series of intersection points of each plane and triangle grid; and
arranging the intersection points into a set of polygons based on the adjacency relationships of the intersection points on the surface of the model.

21. The computer readable medium of claim 20, where said operations comprise:
discarding the polygon slice if the number of closed vertexes constituting the polygonal slice is less than 3.

22. The computer readable medium of claim 20, where when the intersection point belongs to sides of two different triangles, said operations includes retaining the two different sides and marking the intersection point in order to determine definitely which triangle the intersection point belongs to.

23. The computer readable medium of claim 20, wherein when the triangle to which the said intersection point belongs does not lie on said three-dimensional model, the operations comprise:
if the side on which the said intersection point and the adjacent intersection point lie can constitute a triangle, determining the two intersection points to be adjacent vertexes of the polygonal slice; and
if the side on which the two intersection points lie can not constitute a triangle, discarding the two intersection points.

24. The computer readable medium of claim 17, said operations, comprise:
normalizing the similarities with regard to mean D2 distance.

25. (canceled)
